(19) United States
(12) Patent Application Publication
(10) Pub. No.: US 2005/0088284 A1
(43) Pub. Date: Apr. 28, 2005

(54) Method and system of using a RFID reader network to provide a large operating area

(76) Inventors: Li-Cheng Richard Zai, Los Gatos, CA (US); Xinyu Zang, Sunnyvale, CA (US)

Correspondence Address: Diane Dunn McKay, Esq.;Mathews, Collins, Shepherd & McKay, P.A., Suite 306, 100 Thanet Circle, Princeton, NJ, 08540, US

(21) Appl. No.: 10/962,073

(22) Filed: Oct. 8, 2004

Related U.S. Application Data
(60) Provisional application No. 60/509,865, filed on Oct. 9, 2003.

(51) Int. Cl. H04Q 5/22

(52) U.S. Cl. 340/10.2

(57) ABSTRACT

The present invention relates to a method and apparatus for using a RFID reader network to provide a large operating area, thereby enabling multiple RFID readers to simultaneously operate with minimal interference among all the RFID readers in the same network. The RFID network comprises a plurality of RFID readers connected to a server via a network backbone. Each operating RFID reader is associated with a group of neighboring RFID readers. A neighboring RFID reader is defined as a RFID reader that can detect tag responses for the communication between the operating RFID reader and its RFID tags. Each operating RFID reader sends its neighboring RFID readers at least one Tag Operation (TO) packet before starting to communicate with RFID tags and at least one End of Tag Operation (ETO) packet after the tag operation is completed. To avoid interference, each RFID reader uses a listen-before-talk scheme in which it checks if any TO packet has been sent by neighboring RFID readers before starting radio transmission. If both RFID readers are allowed to transmit, the RFID reader with a neighboring RFID reader just finishing transmission has the higher priority. This approach improves the throughput by taking advantage of the overlapped areas of neighboring RFID readers.

### CROSS REFERENCE TO RELATED APPLICATION

This application claims the benefit of U.S. Provisional Patent Application No. 60/509,865 filed Oct. 8, 2003, the entirety of which is hereby incorporated by reference into this application.

### BACKGROUND OF THE INVENTION

1. Field of the Invention

This invention relates generally to RFID (Radio Frequency Identification) systems and more specifically relates to a method and apparatus of using a RFID reader network to provide a large operating area.

2. Description of the Prior Art

RFID tags and readers have recently begun to enter the mass market. FIG. 1 illustrates a typical prior art system in which RFID reader 10 uses multiple antennas 11, 12, 13 and 14 to detect RFID tags 15 and 16 in a relatively large area, such as a loading dock doorway. The reason for the use of multiple antennas to cover a large area is because the typical operating range of a small, passive RFID tag is only 2 to 3 meters from the antenna.

A shortcoming of this prior art system is that the antennas and associated multiplexing circuits and cable connections are not reliable and are expensive. Another shortcoming of this prior art system is that only one antenna is allowed to operate at any time. Therefore the reader throughput is low.

While this prior art system may be suitable for early deployment of RFID applications, it is desirable to provide an improved system for reliability and throughput purposes in which a RFID reader network includes multiple readers.

### SUMMARY OF THE INVENTION

In view of the foregoing disadvantages inherent in RFID systems, the present invention provides a method and apparatus for a RFID reader network thereby allowing a large operating area. The method of using a RFID reader network substantially departs from the concept and design of the prior art, and in so doing provides a reliable reader network in which a plurality of RFID readers can simultaneously operate to provide a large area of coverage with minimal interference among the readers in the same network.

The present invention generally comprises a RFID reader network comprising a plurality of RFID readers connected to a server via a network backbone. In this respect, before explaining at least one embodiment of the invention in detail, it is to be understood that the invention is not limited in its application to the details set forth in the following description and illustrated in the construction and arrangements of components. The invention is capable of other embodiments and being practiced and carried out in various ways. Also, it is to be understood that the phraseology and terminology employed herein are for the purpose of the description and should not be regarded as limiting.

The present invention provides for a method of using a RFID reader network to enable operation in a large operating area, which overcomes the shortcomings of prior art systems.

The present invention also provides for a method to enable a plurality of RFID readers to operate simultaneously thereby providing enhanced throughput.

The present invention also provides for a method to estimate interference among all RFID readers in the network thereby automatically defining a group for each RFID reader.

The present invention also provides for a method that each RFID reader has one or more neighboring RFID readers listen to RFID tag responses while it is communicating with the RFID tags.

The present invention also provides for a method of programming a RFID tag with network information to allow for easy network provisioning.

To the accomplishment of the above, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar pars throughout the several views, and wherein:

FIG. 1 is a schematic diagram of a prior art RFID system.

FIG. 2 is a schematic diagram of a RFID reader network in accordance with the teachings of the present invention.

FIG. 3 is a schematic diagram of a hardware block diagram of an embodiment of the RFID reader of the present invention.

FIG. 4 is a schematic diagram of an embodiment of the RFID reader network including multiple RFID readers.

FIG. 5A is a schematic diagram showing a plurality of RFID readers using information to avoid interference.

FIG. 5B is a table of group information to avoid interference.

FIG. 5C shows short backoff tables for the RFID readers within the same group.

FIG. 6 is a state diagram of an RFID reader used in the RFID reader network.

FIG. 7 is a flow chart of a read/write task in the RFID reader's OPERATION state.

FIG. 8 is a flow chart of a listen task in the RFID reader's OPERATION state.

FIG. 9 is a flow chart of a networking task in the RFID reader's networking state.

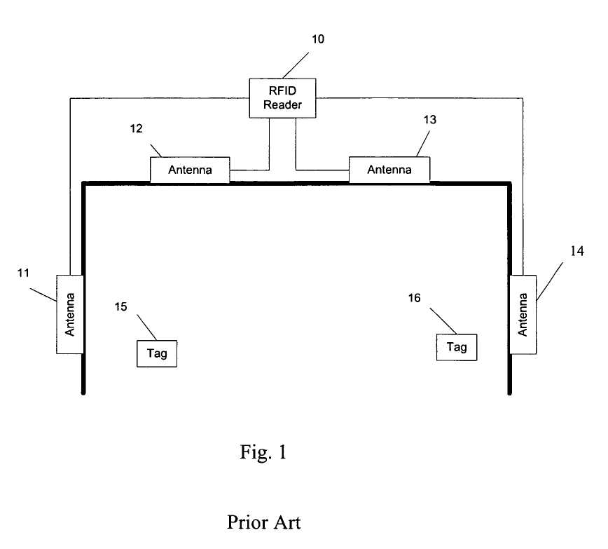

### DESCRIPTION OF THE PREFERRED EMBODIMENT

Reference will now be made in greater detail to a preferred embodiment of the invention, an example of which is illustrated in the accompanying drawings. Wherever possible, the same reference numerals will be used throughout the drawings and the description to refer to the same or like parts.

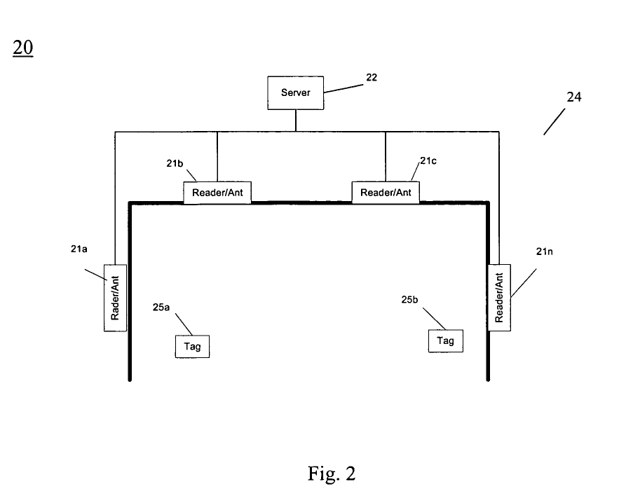

FIG. 2 is a schematic diagram of RFID reader network system 20 in accordance with the teachings of the present invention. RFID reader network system 20 comprises a plurality of RFID readers 21a-21n connected to processing means 22 via network backbone 24. For example, processing means 22 can be a computer server for processing network information and tag data. RFID readers 21a-21n communicate with RFID tags 25a and 25b. It will be appreciated that additional RFID readers and RFID tags can be used in RFID reader network system 20. RFID reader network system 20 provides a large operating area for communication with RFID tags. For example, the operating area can be in a range of about 1 meter to about 15 meters.

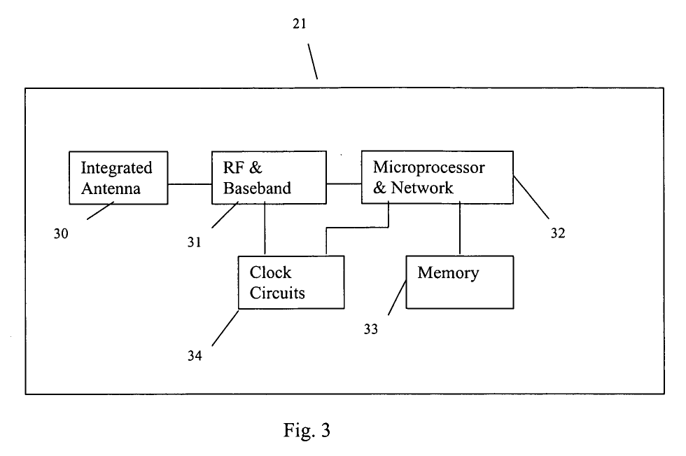

FIG. 3 is a block diagram of RFID reader 21 integrated with an antenna. RFID reader 21 comprises antenna 30, RF and baseband circuits 31, microprocessor and network circuits 32, one or more memory devices 33, and clock circuit 34. RF and baseband circuits 31 provide conventional RF and baseband features. Microprocessor and network circuits 32 provide communication between RFID readers 21a-21n.

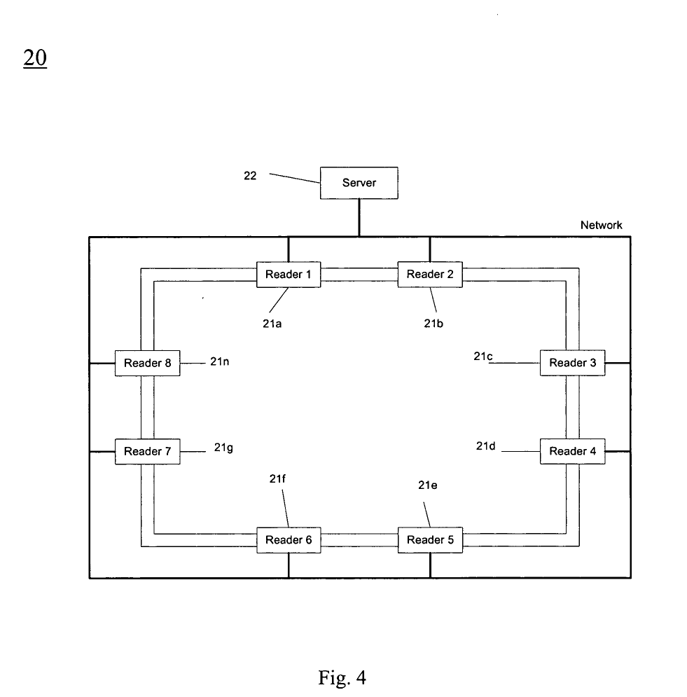

FIG. 4 is a schematic diagram of RFID reader network system 20 including eight RFID readers 21a-21n connected to server 22 to provide a large operating area for system 20. For example, this embodiment can be used in a loading dock doorway. RFID reader 21a is labeled Reader 1. RFID reader 21b is labeled Reader 2. RFID reader 21c is labeled Reader 3. RFID reader 21d is labeled Reader 4. RFID reader 21e is labeled Reader 5. RFID reader 21f is labeled Reader 6. RFID reader 21g is labeled Reader 7. RFID reader 21n is labeled Reader 8. RFID readers 21a-21n use group information to avoid interference between RFID readers.

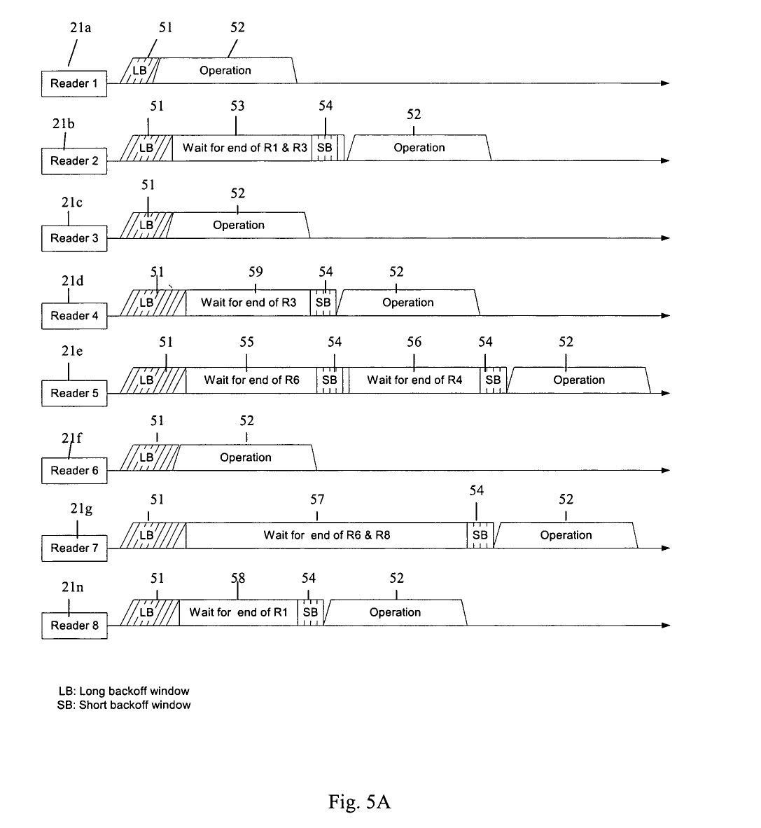

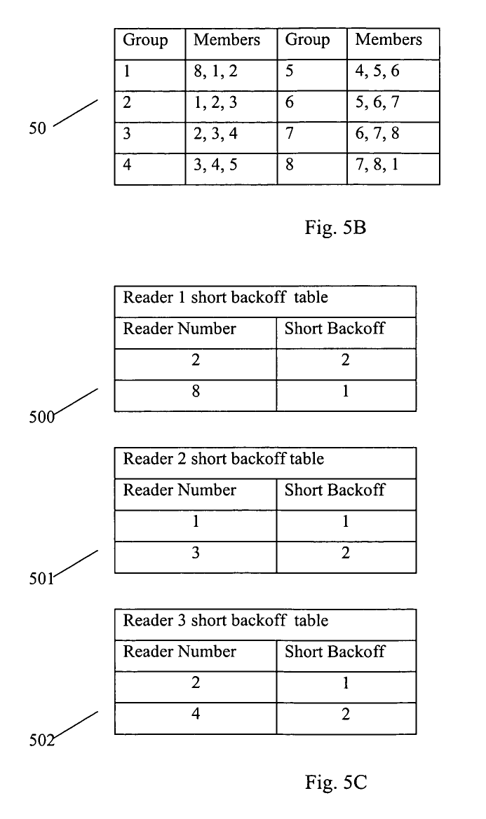

FIGS. 5A-5C illustrate an example of RFID readers 21a-21n using group information 50 to avoid interference in the embodiment of system 20 illustrated in FIG. 4. The groups are formed by sequentially designating each of RFID readers 21 as the operating reader in one network. The operating reader communicates with RFID tags and requests other RFID readers 21 to report the number of RFID tags detected by them to the operating reader. Any reader that detects the RFID tag responses from the operations between the operating RFID readers 21 and RFID tags belongs to the same group associated with the operating reader.

In this example, it is assumed that each RFID reader 21a-21n can cause interference only to its immediate or adjacent neighbors. Group information is listed in table 50. In this example, Group 1, associated with RFID reader 21a (Reader 1), comprises RFID reader 21n (Reader 8), RFID reader 21a (Reader 1) and RFID reader 21b (Reader 2). Group 2, associated with RFID reader 21b (Reader 2), comprises RFID reader 21a (Reader 1), RFID reader 21b (Reader 2) and RFID reader 21c (Reader 3). Group 3, associated with RFID reader 21c (Reader 3), comprises RFID reader 21b (Reader 2), RFID reader 21c (Reader 3) and RFID reader 21d (Reader 4). Group 4, associated with RFID reader 21d (Reader 4), comprises RFID reader 21c (Reader 3), RFID reader 21d (Reader 4), and RFID reader 21e (Reader 5). Group 5, associated with RFID reader 21e (Reader 5), comprises RFID reader 21d (Reader 4), RFID reader 21e (Reader 5), and RFID reader 21f (Reader 6). Group 6, associated with RFID reader 21f (Reader 6), comprises RFID reader 21e (Reader 5), RFID reader 21f (Reader 6) and RFID reader 21g (Reader 7). Group 7, associated with RFID reader 21g (Reader 7), comprises RFID reader 21f (Reader 6), RFID reader 21g (Reader 7), and RFID reader 21n (Reader 8). Group 8, associated with RFID reader 21n (Reader 8), comprises RFID reader 21g (Reader 7), RFID Reader 21n (Reader 8) and RFID reader 21a (Reader 1).

A backoff technique is used to resolve contention among different RFID readers 21 to communicate with RFID tags. A long backoff period 51 is used when there are no RFID readers 21 currently operating in the same group. Long backoff period 51 allows RFID readers 21 within the same group to have higher priority to transmit, so that the reader operations of the same group are less likely to be disrupted by the operations of RFID readers 21 in a different group. For example, long backoff period 51 can be in the range of about 5 milliseconds to about 10 milliseconds seconds. An exponential backoff algorithm can also be applied to the long backoff period 51. For RFID readers 21 in the same group, a short backoff period 54 can be obtained from short backoff tables 501-503. For example, short backoff period 54 can be in the range of about 0 milliseconds to about 5 milliseconds seconds.

Short backoff tables 501-503 contain backoff values related to the interference levels caused by each RFID readers 21 to its neighboring readers. For example, short backoff table 502 residing in RFID reader 21b (Reader 2) shows that RFID reader 21c (Reader 3) detects more tag data than RFID reader 21a (Reader 1) does while RFID reader 21b (Reader 2) is reading the RFID tags. In this case, RFID reader 21b (Reader 2) waits for short backoff time 54 of 1 milliseconds after RFID reader 21a (Reader 1) ceases its operation and short backoff time 54 of 2 milliseconds after RFID reader 21c (Reader 3) finishes its operation.

RFID readers 21a-21n receive an event for starting a read/write operation. After all RFID readers 21a-21n receive the event for starting a read/write operation, each of RFID readers 21a-21n performs a long backoff period 51. After long backoff period 51, RFID reader 21a (Reader 1), RFID reader 21c (Reader 3), and RFID reader 21f (Reader 6) begin read/write operation 52. RFID reader 21b (Reader 2) is part of Group 2 having RFID reader 21a (Reader 1) and RFID reader 21c (Reader 3) as members. Therefore, RFID reader 21b (Reader 2) waits in block 53 until both RFID reader 21a (Reader 1) and RFID reader 21c (Reader 3) complete their operations.

RFID reader 21d (Reader 4) is part of Group 4 having RFID reader 21c (Reader 3) and RFID reader 21e (Reader 5) as members. RFID reader 21d (Reader 4) waits in block 54 for RFID reader 21c (Reader 3) to complete its operation in block 59. RFID reader 21e (Reader 5) is part of Group 5 having RFID reader 21d (Reader 4), and RFID reader 21f (Reader 6) as members. RFID reader 21e (Reader 5) waits in block 55 until RFID reader 21f (Reader 6) completes its operation. After RFID reader 21f (Reader 6) finishes its operation, RFID reader 21e (Reader 5) performs short backoff window 54 and finds that RFID reader 21d (Reader 4) is communicating with RFID tags. Accordingly, RFID reader 21e (Reader 5) waits in block 56 until RFID reader 21d (Reader 4) completes it operation. RFID reader 21g (Reader 7) is part of Group 7 having RFID reader 21f (Reader 6) and RFID reader 21n (Reader 8) as members. RFID reader 21g (Reader 7) waits in block 57 for RFID reader 21f (Reader 6) and RFID reader 21n (Reader 8) to complete their operations. RFID reader 21n (Reader 8) is part of group 8 having RFID reader 21g (Reader 7) and RFID reader 21a (Reader 1) as members. RFID reader 21n (Reader 8) waits in block 58 for RFID reader 21a (Reader 1) to cease its operation. Thereafter, RFID reader 21n (Reader 8) performs short backoff window 54 before starting operation 52.

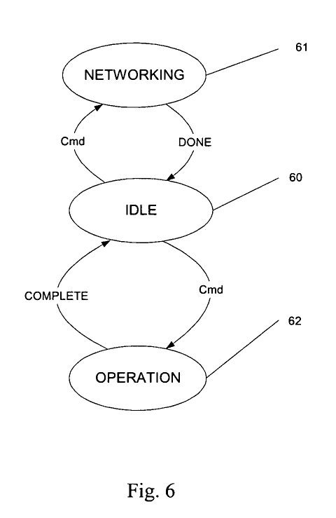

FIG. 6 is a state diagram of RFID reader 21. RFID reader 21 stays in IDLE state 60 after powering up. RFID reader 21 moves to NETWORKING state 61 if it receives a networking command or a trigger from an external device, such as a push button, of RFID reader 21. Networking state 61 is used to execute necessary tasks to form RFID reader network 29. After RFID reader 21 completes the networking process, it returns to IDLE state 60. If RFID reader 21 receives an operation command generated by a server or external devices, such as motion detectors, RFID reader 21 moves to OPERATION state 62. In operation state 62, RFID reader 21 runs tasks including read and write of data to RFID tags.

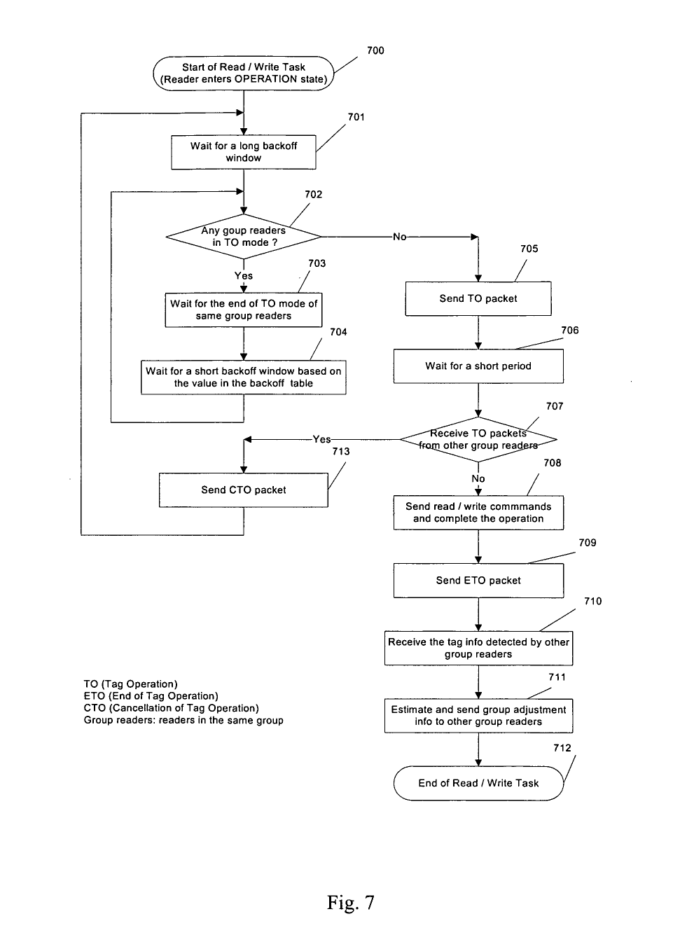

FIG. 7 is a flow chart of an embodiment of a RFID reader 21 read/write task in RFID reader 21 OPERATION state 62. The task starts from Step 700 and waits for long backoff window 51 in Step 701. In Step 702, the task checks whether any other RFID readers are in Tag Operation (TO) mode by detecting incoming TO packets from the other readers in the same group. If there is one or more TO packets, the task waits for the End of Tag Operation (ETO) packets or Cancellation of Tag Operation (CTO), which are sent from other RFID readers in the same group in Step 703. Thereafter, in Step 704, the task takes a short backoff period based on the value in the backoff table if one or more of its neighboring readers are just finishing their operations and then goes back to Step 702.

If no TO packets are received in Step 702, the task sends at least one TO packet to the other RFID readers 21 in the same group in Step 705. Thereafter, the task waits for a short period of time in the range of microseconds in Step 706. In Step 707, the task checks if there is any collision due to receiving TO packets from other RFID readers 21 in the group. If there is any collision, the task moves to Step 713 for sending at least one Cancellation of Tag Operation (CTO) packet to the neighboring RFID readers 21. If there is not any collision, the task moves to Step 708 to communicate with RFID tags, such as by sending read/write commands. In Step 709, at least one End of Tag Operation (ETO) packet is sent when the task completes the tag operation. After receiving the at least one ETO packet, other neighboring RFID readers 21 send tag information, such as tag IDs and number of tags, detected by them to the task in Step 710. The task uses this tag information to estimate the interference levels and sends adjustment information to each neighboring RFID reader 21 in the same group in Step 711. The interference levels of each RFID reader 21 to other neighboring members in the same group is typically proportional to the number of tags detected by these readers while it is in operation. Each neighboring RFID reader 21 uses the adjustment information to update its short backoff table. The task ends in Step 712.

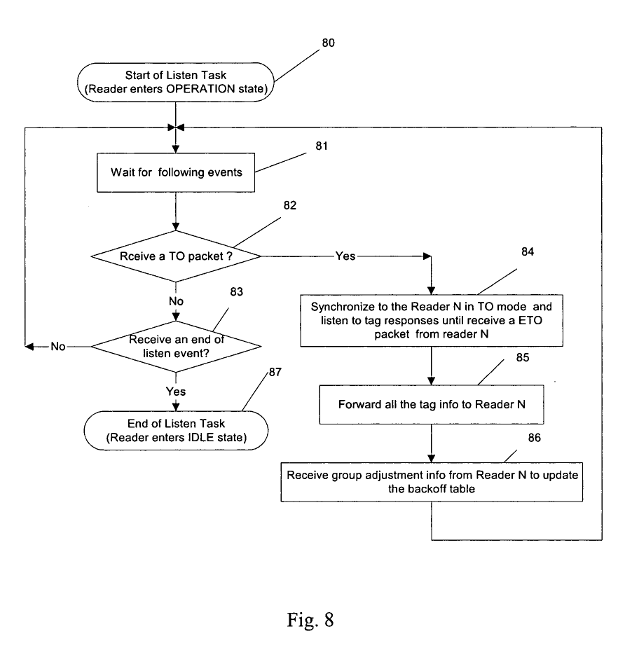

FIG. 8 is a flow chart of a listen task in RFID reader 21 OPERATION state 62. The task starts from Step 80 and waits for an event of the detection of either a TO packet or an event to end the listen task in Step 81. If a TO packet is received in Step 82, the task instructs RFID reader 21 to synchronize with other RFID reader 21 in transmission and listen to tag responses until a ETO packet is received in Step 84. The task then forwards the information of detected tags to RFID reader 21 just finishing transmission in Step 85. The task receives the group adjustment information to update the short backoff table in Step 86 and goes back to Step 81 to wait for the following events. If the task receives an end of listen event in Step 83, the task ends in Step 87.

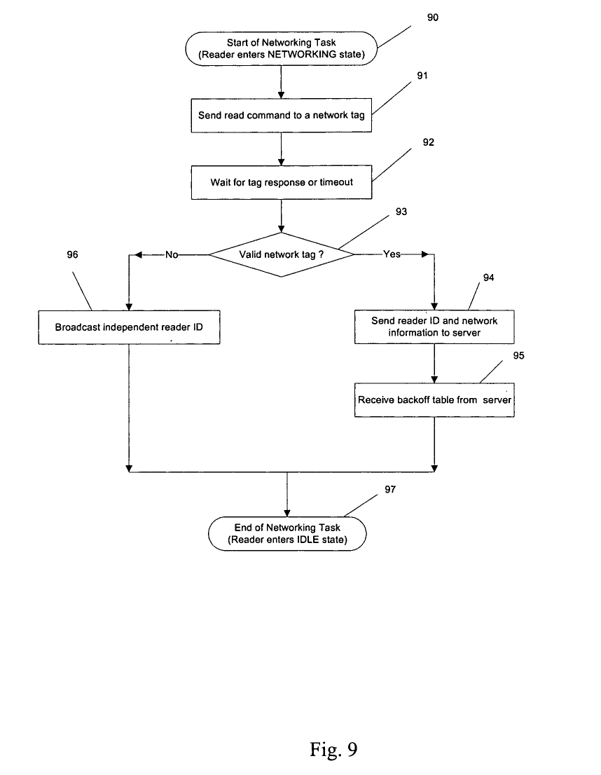

FIG. 9 is a flow chart of a networking task in RFID reader 21 NETWORKING state 61. The task starts from Step 90 and sends a read command to a network tag that contains network information in Step 91. For example, the network information can be an ID and IP address. In Step 92, the task waits for a network tag response or a time out. The task determines if a valid network tag response was received in Step 93. If the tag response is not a valid network tag or a timeout event occurs in Step 92, the task goes to Step 96 and broadcasts the RFID reader ID as an independent reader. If the task detects a valid network tag in Step 93, it sends an identification of the RFID reader 21 and network information to server 22 in Step 94. In Step 95, the task receives the short backoff table from the server. The task ends in Step 97.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

1. A RFID system comprising:
a plurality of RFID readers;
network means for networking said plurality of RFID readers; and
means for avoiding interference among said plurality of RFID readers;
wherein each of said plurality of RFID readers are operated in sequence or simultaneously with other ones of said plurality of RFID readers for avoiding interference.

2. The RFID system of claim 1 wherein said means for avoiding interference comprises:
a group table at each of said plurality of RFID readers, said group table comprising at least one entry of at least one neighboring one of said plurality of RFID readers that can provide interference and each of said RFID readers is operated to transmit if none of said at least one neighboring one of said plurality of RFID readers of said at least one entry in said group table is in a transmission mode.

3. The RFID system of claim 2 wherein said RFID reader has said group table, wherein each of neighboring one of said plurality of RFID readers sends at least one tag operation (TO) packet to each of said at least one neighboring one of said plurality of group readers of said at least one entry in said group table before communicating with a RFID tag.

4. The RFID system of claim 3 wherein each of neighboring one of said plurality of RFID readers sends at least one end of tag operation (ETO) packet after communication is completed with said RFID tag.

5. The RFID system of claim 4 further comprising:
a short backoff table at each of said plurality of RFID readers;
said short backoff table comprising at least one short backoff value determined from said interference levels of said at least one neighboring one of said plurality of RFID readers,
wherein each of said RFID readers is operated to transmit after said at least one short backoff value.

6. The RFID system of claim 5 wherein said short backoff table is updated after receiving an end of tag operation (ETO) packet and RFID tag information detected by other of said at least one neighboring one of said plurality of RFID readers.

7. The RFID system of claim 1 wherein said interference level of said operating reader to each of said plurality of RFID readers is proportional to the number of detected RFID tags by said each of said plurality of RFID readers while said operating reader is communicating with said RFID tags.

8. The RFID system of claim 1 wherein said networking means comprises:
a network backbone connecting said plurality of RFID readers; and
processing means for processing network information and tag data.

9. The system of claim 1 wherein if two of said RFID readers are operated to transmit one of said two of said RFID readers operated to transmit which has recently had said at least one neighboring one of said plurality of RFID readers of said at least one entry in said group table in a transmission mode is operated to transmit before said other one of said two of said RFID readers operated to transmit.

10. A method of operating a RFID system comprising the steps of:
a. establishing a network of a plurality of RFID readers;
b. forming a RFID reader group by estimating an interference level between each of said plurality of RFID readers; and
c. operating said plurality of RFID readers in sequence or simultaneously with other ones of said plurality of RFID readers based on said determined interference level.

11. The method of claim 10 further comprising the steps of:
wherein in said step c. each of said RFID readers is operated to transmit if none of other ones of said plurality of RFID readers in said group is in a transmission mode.

12. The method of claim 11 further comprising the steps of:
said RFID reader that is operated to transmit sends to said other ones of said plurality of RFID readers in said group at least one tag operation (TO) packet before starting to communicate with a RFID tag and at least one end of tag operation (ETO) packet after communication is completed with said RFID tag.

13. The method of claim 12 wherein said other ones of said plurality of RFID readers in said group listen for said at least one tag operation (TO) packet and wait for said at least one end of tag operation (ETO) packet or cancellation of tag operation (CTO) before communicating with an RFID tag.

14. The method of claim 13 further comprising the step of:
establishing a short backoff table at each of said plurality of RFID readers;
said short backoff table comprising at least one short backoff value determined from said interference levels of said plurality of RFID readers,
wherein in said step c. said each of said RFID readers is operated to transmit after said at least one short backoff value.

15. The method of claim 14 further comprising the step of:
updating said short backoff table after receiving an end of tag operation (ETO) packet and RFID tag information from said plurality of RFID readers in said group.

16. The method of claim 14 further comprising the steps of:
checking for collisions due to receiving said at least tag operation (TO) packets from said other RFID readers in said group; and
if there is a collision, sending a cancellation tag operation (CTO) to said other RFID readers in said group.

17. The method of claim 11 wherein said step of establishing a group of said plurality of RFID readers comprises the steps of:
sequentially operating each of said plurality of RFID readers to read a group of tags as an operating RFID reader;
instructing other ones of said RFID readers in said network to synchronize to said operating RFID reader;
listening for tag responses of said other ones of said plurality of RFID readers;
sending tag information of said tags responses to said operating RFID reader; and
using said tag information detected by other ones of said RFID readers to establish said group such that any RFID readers that detects said tag responses from the operations between the operating RFID reader and RFID tags belongs to the same group associated with said operating RFID reader.

18. The method of claim 10 wherein said interference level is proportional to the number of detected RFID tags by said each of said plurality of RFID readers while said operating reader is communicating with said RFID tags.

19. The method of claim 10 wherein in said step a, each of said plurality of RFID reader are in an IDLE state until receiving a network command or a trigger from an external device and after receiving said network command or trigger moving said RFID reader into a NETWORKING state.

20. The method of claim 19 wherein said RFID reader in said NETWORKING state reads a network RFID tag comprising network information and sends said RFID reader identification and network information of said RFID reader in said NETWORKING state to a server connected to said network.

21. The method of claim 19 wherein step c. further comprises the steps of:
moving one of said RFID readers into an OPERATION state if said one of said RFID readers receives an operation command.

22. The method of claim 21 wherein said operation command is generated by a network server or an external device.

23. A method for improving RFID tag detection in a RFID system comprising the steps of:
synchronizing at least one RFID reader to a RFID transmitting reader;
simultaneously listening at each said synchronized at least one RFID reader to RFID tag responses;
forwarding said RFID tag responses to said transmitting reader; and
operating said transmitting reader based on said RFID tag responses.

24. The method of claim 23 wherein said at least one RFID reader is synchronized to said RFID transmitting reader based on a level of interference between said at least one RFID reader and said transmitting reader.

25. The method of claim 24 wherein said interference level is proportional to a number of detected RFID tags by said at least one RFID reader.
